(19) United States
(12) Patent Application Publication
(10) Pub. No.: US 2020/0157265 A1
(43) Pub. Date: May 21, 2020

(54) Low Viscosity UV-Curable Formulation For 3D Printing

(71) Applicants: Sivapackia Ganapathiappan, Los Altos, CA (US); Ankit Vora, Bothell, WA (US); Boyi Fu, San Jose, CA (US)

(72) Inventors: Sivapackia Ganapathiappan, Los Altos, CA (US); Ankit Vora, Bothell, WA (US); Boyi Fu, San Jose, CA (US)

(21) Appl. No.: 16/683,112

(22) Filed: Nov. 13, 2019

Related U.S. Application Data
(60) Provisional application No. 62/769,493, filed on Nov. 19, 2018.

(51) Int. Cl. C08F 220/56; C09D 11/30; C09D 11/101; C09D 11/107; C08F 220/18; C08F 220/36; B33Y 10/00; B33Y 70/00; B29C 64/112

(52) U.S. Cl. CPC C08F 220/56; C09D 11/30; C09D 11/101; C09D 11/107; C08F 220/18; B33Y 80/00; B33Y 10/00; B33Y 70/00; B29C 64/112; C08F 2220/365; C08F 220/36

(57) ABSTRACT

A liquid precursor material for dispensing in an additive manufacturing process includes a meth(acrylate) functional oligomer, a reactive diluent, a meth(acrylamide) monomer, and a N-vinyl containing monomer.

### CROSS-REFERENCE TO RELATED APPLICATIONS

This application claims priority to U.S. Application Ser. No. 62/769,493, filed on Nov. 19, 2018, the disclosure of which is incorporated by reference.

### TECHNICAL FIELD

This invention relates to additive manufacturing, and more particularly to a composition for ejection in an additive manufacturing system.

### BACKGROUND

Additive manufacturing (AM), also known as solid freeform fabrication or 3D printing, refers to a manufacturing process where three-dimensional objects are built up from successive dispensing of raw material (e.g., powders, liquids, suspensions, or molten solids) into two-dimensional layers. In contrast, traditional machining techniques involve subtractive processes in which articles are cut out from a stock material (e.g., a block of wood, plastic, composite or metal).

Polishing pads for chemical mechanical polishing are typically made by molding or casting polyurethane materials. In the case molding, the polishing pads can be made one at a time, e.g., by injection molding. In the case of casting, the liquid precursor is cast and cured into a cake, which is subsequently sliced into individual pad pieces. These pad pieces can then be machined to a final thickness. Grooves can be machined into the polishing surface, or be formed as part of the injection molding process.

Polishing pads can also be fabricated by 3D printing techniques. A liquid precursor material can be dispensed from a nozzle that moves over a support and cured to form a layer of the polishing pad.

### SUMMARY

In one aspect, a liquid precursor material for dispensing in an additive manufacturing process includes a meth(acrylate) functional oligomer, a reactive diluent, a meth(acrylamide) monomer, and a N-vinyl containing monomer.

In another aspect, a method of fabricating a polishing layer of a polishing pad includes successively depositing a plurality of sublayers of a polishing layer with a 3D printer. Each sublayer of the plurality of sublayers layers is deposited by ejecting a liquid precursor material from a nozzle, the precursor material including a meth(acrylate) functional oligomer, a reactive diluent, a meth(acrylamide) monomer, and a N-vinyl containing monomer, and curing the precursor material to solidify the precursor material to form a solidified polishing layer material of the sublayer.

Potential advantages may include, but are not limited to, one or more of the following.

The precursor material can have reduced viscosity, but can also have a fast cure, a high modulus, and a high ultimate tensile strength (UTS). Moreover, these properties can be achieved while maintaining low water-uptake of the final cured part. In addition, higher loading of high molecular weight (MW) oligomers could be added, enabling tougher layers (i.e., layers with higher elongation-to-break while maintaining UTS). By tuning the formulation composition, it is possible to reduce the water uptake of the UV-curable formulations comprising acrylamide or N-vinyl containing monomers to <10% of the original weight after soaking in room temperature water for four days. This can be especially desirable for parts made by inkjet-based 3D printing technology.

The details of one or more embodiments are set forth in the accompanying drawings and the description below. Other features, objects, and advantages will be apparent from the description and drawings, and from the claims.

### DESCRIPTION OF DRAWINGS

FIG. 1 is a schematic cross-sectional side view illustrating an exemplary additive manufacturing system.

FIG. 2 is a table that lists control UV cross-linkable formulations.

FIG. 3 is a table that lists several formulations with acrylamide and N-vinyl monomers.

FIG. 4 is a table that lists several formulations that were 3D printed.

FIG. 5 is table that lists mechanical properties of 3D printed specimens of formulations from FIG. 4.

FIGS. 6A and 6B are schematic cross-sectional side views of example polishing pads.

Like reference symbols in the various drawings indicate like elements.

### DETAILED DESCRIPTION

For many 3D printing techniques that use light-based curing, e.g., UV-curing, low viscosity formulations are highly desirable. This can be important for inkjet-based 3D printing techniques in which the viscosity of the final formulation needs to be between 10-20 cP at the jetting temperature (60-90° C.). Conventionally, in order to achieve such low viscosity, the formulation is dominated (˜70-80%) by low viscosity reactive diluents and just 20-25% of the formulation is the high viscosity oligomers that provide the required mechanical properties to the final layers. Thus in most instances, the final UV-cured layer obtained by inkjet-based 3D technology is very brittle and hard, as opposed to the tougher materials that can be obtained by step-growth polymerization techniques.

Most reactive diluents used for UV-curable layers are a combination of acrylate and methacrylate monomers with mono, di, tri or tetra-functional reactive (meth)acrylate groups. One such commonly used acrylate monomer is isobornyl acrylate that has a RT viscosity of ˜8 cP and Tg of ˜90 C. Other methacrylate monomers with lower viscosity like cyclohexyl methacrylate and methyl methacrylate are also used as reactive diluents. However, formulations based on these monomers are very slow to cure or need a very high dose of radiation to complete curing due to the slower reactivity of the methacrylate group. This makes such monomers impractical to use in larger quantities in a formulation.

However, formulations including acrylamide and N-vinyl containing monomers, e.g., N,N dimethylacrylamide, N,N diethylacrylamide and N-vinyl pyrrolidone, can address these problems.

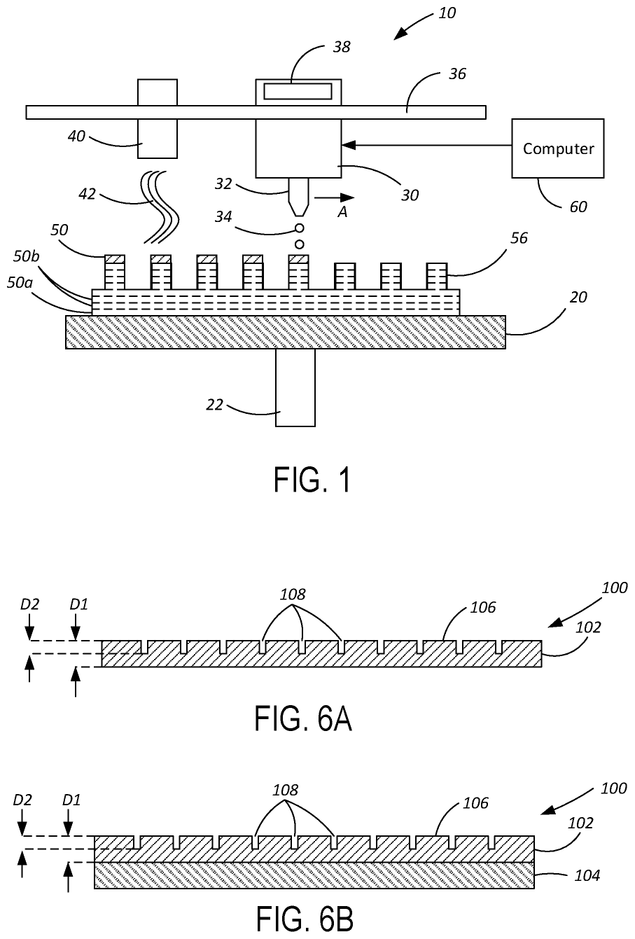

FIG. 1 is a simplified illustration of an example system 10 for manufacturing a part, e.g., a polishing pad, using a 3D printing process. The system 10 includes a support 20 on which the part is fabricated, and droplet ejecting printhead 30 with one or more nozzles 32 from which droplets 34 of a liquid precursor material can be ejected. The droplet ejecting printer can be similar to an inkjet printer, but uses the precursor material rather than ink. The printhead 30 and nozzle 32 can translate (shown by arrow A) across the support 20. For example, the printhead 30 can be supported on a linear track 36 and be driven along the track 36 by a linear actuator 38, e.g., a screw drive motor. Alternatively, the printhead 30 can be stationary and the support 20 can be moved horizontally by a motor.

In some implementations, the support 20 can be moved by a vertical actuator 22. For example, after each layer is deposited, the support 20 can be lowered by a distance equal to the thickness of the layer just deposited. Alternatively or in addition, the printhead 30 can be moved vertically, e.g., to provide some or all of the vertical displacement. This can ensure a uniform distance between the nozzle 32 and the surface onto which the droplets 34 are being deposited, which can improve uniformity of fabrication and simplify control electronics.

The support 20 can be a rigid base, or be a flexible film, e.g., a layer of polytetrafluoroethylene (PTFE). If the support 20 is a film, then the support 20 can form a portion of the part. For example, the support 20 can form a backing layer or a layer between the backing layer and the polishing layer of a polishing pad. Alternatively, the part can be removed from the support 20.

Although FIG. 1 illustrates a single nozzle 32, in practice the printhead 30 can include a linear array of independently controllable nozzles. The nozzles can extend parallel to the support surface and in a direction oblique or perpendicular to the direction of motion of the printhead 30. The array of nozzles 32 can span the width of the build area of the support 20.

The system 10 also includes an energy source 40 to emit radiation 42 to solidify, e.g., cure, the liquid precursor material 34. For example, the energy source 40 can include one or move UV lamps. For example, the energy source 40 can include a linear array of LEDs, e.g., UV-emitting diodes. The linear array of LEDs can span the width of the build area of the support 20. The energy source 40 can also translate across the support 20, e.g., in the same direction as the printhead 30. For example, the printhead 30 and energy source 40 can be supported on a common frame that is moved as a unit, or the printhead 30 and energy source 40 could be independently movable along the same or different tracks.

Solidification can be accomplished by polymerization. For example, the layer 50 of pad precursor material can be a monomer, and the monomer can be polymerized in-situ by ultraviolet (UV) curing. The pad precursor material can be cured effectively immediately upon deposition, or an entire layer 50 of pad precursor material can be deposited and then the entire layer 50 be cured simultaneously.

In the manufacturing process, thin layers of material are progressively deposited and solidified. For example, droplets 34 of the precursor material are ejected from the nozzle 32 to form a layer 50. For a first layer 50a deposited, the nozzle 34 can eject onto the support 20. For subsequently deposited layers 50b, the nozzle 34 can eject onto an already solidified layer of material 56. After each layer 50 is solidified, a new layer is then deposited over the previously deposited layer until the full 3-dimensional part, e.g., the polishing pad, is fabricated. Each layer 50 is less than 50% of the total thickness of the part, e.g., less than 10%, e.g., less than 5%, e.g., less than 1%.

A computer 60 can control ejection of droplets from the various nozzles 34 so that as the printhead 30 moves relative to the support, each layer is applied in a pattern stored as data in a non-transitory computer readable medium, e.g., in a 3D drawing computer program, on the computer 60. The computer 60 can control the various actuators, e.g., to control speed of translation of the printhead 30 and/or energy source 40, control the energy source 40, e.g., to control the intensity of the radiation 42 and thus the cure speed, and control vertical actuator of the support 20.

The liquid precursor material of the droplets 34 can be a formulation that includes acrylamide and N-vinyl containing monomers, e.g., N,N dimethylacrylamide, N,N diethylacrylamide and/or N-vinyl pyrrolidone. Such a formulation can have a low viscosity be suitable to form UV-curable layers in additive manufacturing, e.g., inkjet-based 3D printing. However, the formulation can also be used for other 3D printing techniques, e.g., stereolithographic (SLA) or digital light processing (DLP) printing. In addition, the formulation can also be applicable in other applications, e.g., coatings on other objects, e.g., protective coatings. Potential applications of these 3D-printed parts include functional and prototyping applications, as well as fabrication of polishing pads for chemical mechanical planarization (CMP) for semiconductor fabrication.

UV-curable monomers such as acrylamide and N-vinyl monomers have been previously used for UV-curable formulations outside of 3D printing for high water-uptake systems like hydrogels, due to the high water solubility of these monomers. Surprisingly, it was discovered that such formulations can provide reduced viscosity, but can also have a fast cure, a high modulus, and a high ultimate tensile strength (UTS). Moreover, these properties can be achieved while maintaining low water-uptake of the final cured part. In addition, higher loading of high molecular weight (MW) oligomers could be added, enabling tougher layers (i.e., layers with higher elongation-to-break while maintaining UTS). By tuning the formulation composition, it is possible to reduce the water uptake of the UV-curable formulations comprising acrylamide or N-vinyl containing monomers to <10% of the original weight after soaking in room temperature water for four days. This can be especially desirable for parts made by inkjet-based 3D printing technology.

The formulation includes a meth(acrylate) functional oligomer, a reactive diluent, a meth(acrylamide) monomer, and a N-vinyl containing monomer. The reactive diluent can be an aliphatic, cycloaliphatic, heterocyclic, aromatic, linear, or branched meth(acrylate) monomer. The N-vinyl containing monomer can include be N,N dimethylacrylamide, N,N diethylacrylamide and/or N-vinyl pyrrolidone. The formulation can also include a photoinitiator, photosensitizer, and/or oxygen scavenger, to improve performance. However, chemically reacting portions of the formulation can include only, e.g., consist of, the meth(acrylate) functional oligomer, reactive diluent, meth(acrylamide) monomer, and N-vinyl containing monomer.

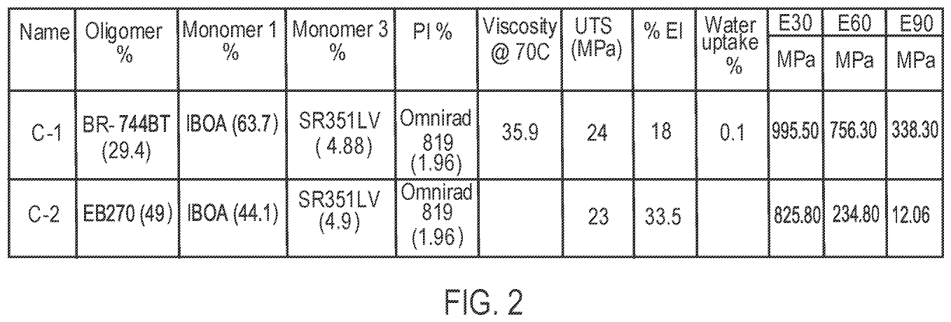

FIG. 2 is a table that lists compositions of control UV cross-linkable formulations using EB270 oligomer (aliphatic urethane acrylate) and BR744BT oligomer (aliphatic polyester urethane acrylate). Monomer 1 is isobornyl acrylate (IBOA). Monomer 3 is low viscosity trimethylolpropane triacrylate (TMPTA) available from Sartomer Americas under the trade designation “SR 351 LV”. The photoinitiator (PI) is Omnirad™ 819 available from IGM Resins USA Inc. having headquarters in Charlotte, N.C., USA. The weight percent (%) of the oligomer, monomer 1, monomer 3, and photoinitiator are given. The viscosity is given in centipoise (cP) at 70° C. in the tables of FIGS. 2-5. The ultimate tensile strength (UTS) is given in millipascals (MPa). The % EI is percent elongation at break. The storage modulus is given at 30° C. (E30), 60° C. (E60), and 90° C. (E90).

As shown in the table of FIG. 2, for two of the representative oligomers, the viscosities of the two model formulations are too high and the mechanical properties are still poor for rapid prototyping or functional-part production by 3D-printing.

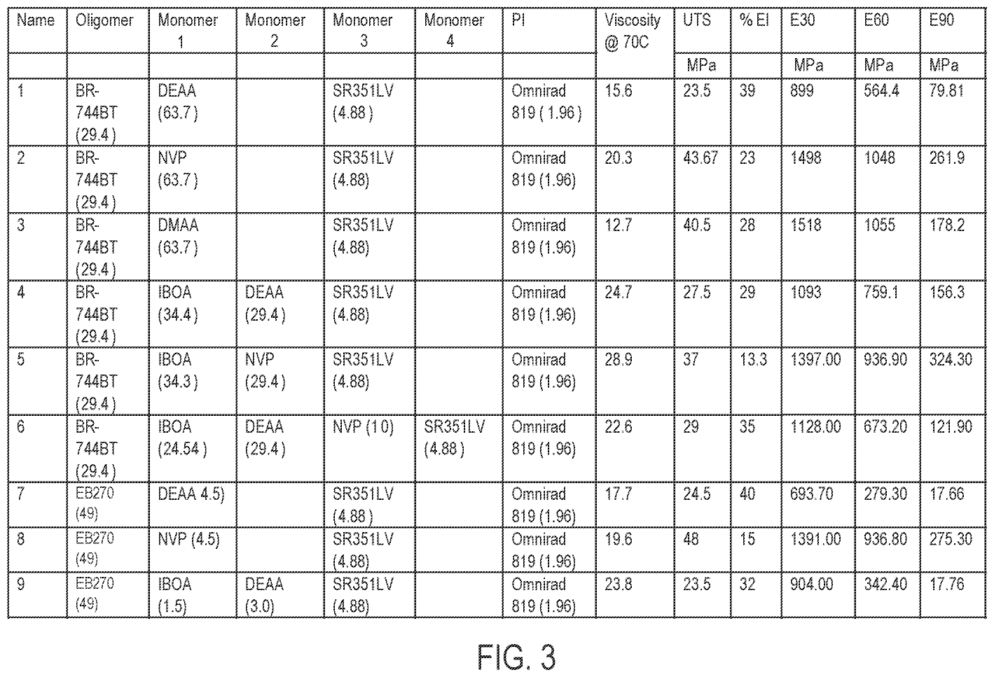

FIG. 3 is a table that lists several formulations with acrylamide and N-vinyl monomers that have lower viscosities and better mechanical properties than the control formulations in the table of FIG. 2. The monomer DEAA is N,N-diethyl acrylamide. The monomer DMAA is N,N-dimethyl acrylamide. The monomer NVP is N-vinylpyrrolidone. The weight percent (%) for the oligomer, monomer 1, monomer 2, monomer 3, monomer 4, and photoinitiator (PI) are given in parenthesis.

For 3D printing techniques like DLP, SLA and poly-jet techniques, lower viscosity formulations that enable rapid-prototyping or functional-parts production are highly desirable. Lower viscosity formulations are easier to handle and provides higher resolution upon printing. In order to achieve such low viscosity, the ink composition can dominated, e.g., at least about 50%, e.g., 70-80%, by low viscosity liquids, e.g., the meth(acrylate) monomer, meth(acrylamide) monomer, and a N-vinyl containing monomer. About 20-30%, e.g., 20-25%, of the composition can be the high viscosity oligomer that provides the required mechanical properties to the final cured layer.

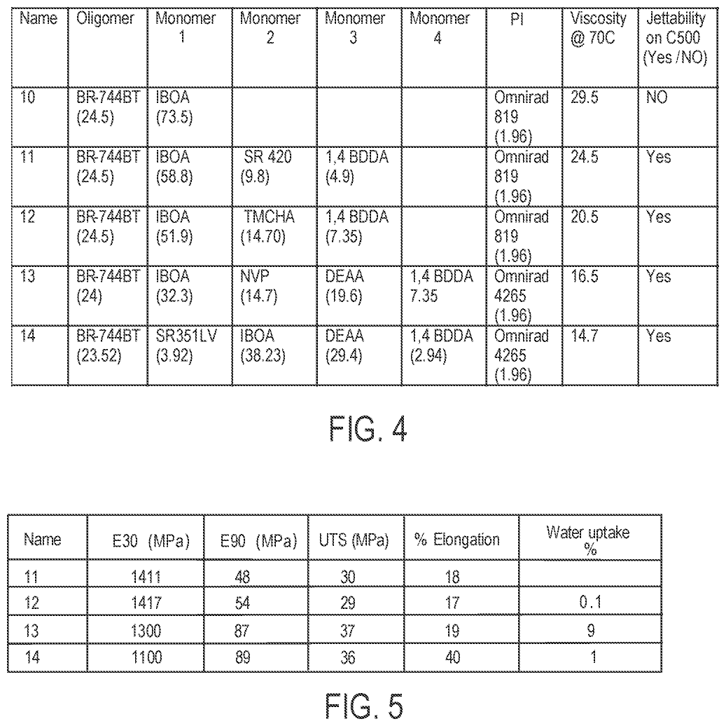

FIG. 4 is a table that lists several formulations (#10-14) that were 3D printed using a Connex 500 printer from Stratasys to form Type IV and Type V dog-bones and DMA coupon samples. The 3D printed samples were cured at 90° C. for one hour after printing at which point they were cooled to room temperature. All samples were characterized 24 hours after leaving them at room temperature. The samples were characterized for UTS, % elongation at break, storage modulus at 30 C and 90 C and water uptake after 96 hours soak-test at room temperature. Preferred values for the 3D printed samples are UTS, % elongation, E30, E90 and water uptake at 25-35 MPa, 20-75%, ˜1 GPa-1.5 GPa, 35-200 MPa and >10% respectively.

In the table in FIG. 4, the weight percent (%) for the oligomer, monomer 1, monomer 2, monomer 3, monomer 4, and photoinitiator (PI) are given in parenthesis. The monomer SR 420 is a very-low viscosity monofunctional acrylic monomer from Sartomer Americas. The monomer TMCHA is 3,3,5-trimethylcyclohexyl methacrylate. The monomer 1.4 BDDA is 1,4-butanediol diacrylate.

FIG. 5 is table that lists mechanical properties of 3D printed specimens of formulations #11-#14 from the table of FIG. 4.

Formulations comprising acrylamide and N-vinyl monomers with low viscosities are particularly desirable for additive manufacturing. One such application of formulation using poly-jet 3D printing technique is for making advanced chemical mechanical polishing (CMP) pads with higher elongation and UTS. The viscosity range of the formulation at the jetting temperature can be between 10-25 cP, e.g., between 12-20 cP, e.g., between 13-16 cP at the jetting temperature. The jetting temperature for such formulations can be between 50-100° C., e.g., between 55-80° C., e.g., between 60-70° C.

FIGS. 6A and 6B illustrate polishing pads 100 that can be fabricating by additive manufacturing using the formulation of precursor material discussed above and in tables 3 and 4. As shown in FIG. 6A, the polishing pad 100 can be a single-layer pad that consists of a polishing layer 102 fabricated by additive manufacturing using the aforementioned precursor material. Alternatively, as shown in FIG. 6B, the polishing pad 100 can be a multi-layer pad that includes the polishing layer 102 and at least one backing layer 104.

The polishing layer 102 can be a material that is inert in the polishing process. The polishing layer 102 can have a hardness of about 40 to 80, e.g., 50 to 65, on the Shore D scale. In some implementations, the polishing layer 102 can be a layer of homogeneous composition. In some implementations, the polishing layer 102 includes pores, e.g., small voids. The pores can be 50-100 microns wide.

The polishing layer 102 can have a thickness D1 of 80 mils or less, e.g., 50 mils or less, e.g., 25 mils or less. Because the conditioning process tends to wear away the cover layer, the thickness of the polishing layer 102 can be selected to provide the polishing pad 100 with a useful lifetime, e.g., 3000 polishing and conditioning cycles.

On a microscopic scale, the polishing surface 106 of the polishing layer 102 can have rough surface texture, e.g., 2-4 microns rms. For example, the polishing layer 102 can be subject to a grinding or conditioning process to generate the rough surface texture. In addition, 3D printing can provide small uniform features, e.g., down to 200 microns.

Although the polishing surface 106 can be rough on a microscopic scale, the polishing layer 106 can have good thickness uniformity on the macroscopic scale of the polishing pad itself (this uniformity refer to the global variation in height of the polishing surface 106 relative to the bottom surface of the polishing layer, and does not count any macroscopic grooves or perforations deliberately formed in the polishing layer). For example, the thickness non-uniformity can be less than 1 mil.

Optionally, at least a portion of the polishing surface 106 can include a plurality of grooves 108 formed therein for carrying slurry. The grooves 108 can be formed by simply not ejecting the precursor material at the locations corresponding to the grooves. The grooves 108 may be of nearly any pattern, such as concentric circles, straight lines, a cross-hatched, spirals, and the like. Assuming grooves 108 are present, then the polishing surface 106, i.e., the plateaus between the grooves 108, can be about i.e., can be 25-90% of the total horizontal surface area of the polishing pad 100. Thus, the grooves 108 can occupy 10%-75% of the total horizontal surface area of the polishing pad 18. The plateaus between the grooves 26 can have a lateral width of about 0.1 to 2.5 mm.

In some implementations, e.g., if there is a backing layer 104, the grooves 108 can extend entirely through the polishing layer 102. In some implementations, the grooves 108 can extend through about 20-80%, e.g., 40%, of the thickness of the polishing layer 102. The depth D2 of the grooves 108 can be 0.25 to 1 mm. For example, in a polishing pad 100 having a polishing layer 102 that is 50 mils thick, the grooves 108 can have a depth D2 of about 20 mils.

The backing layer 104 can be softer and more compressible than the polishing layer 102. The backing layer 104 can have a hardness of 80 or less on the Shore A scale, e.g., a hardness of about have a hardness of 60 Shore A. The backing layer 104 can be thicker or thinner or the same thickness as the polishing layer 102.

For example, the backing layer can be an open-cell or a closed-cell foam, such as polyurethane or polysilicone with voids, so that under pressure the cells collapse and the backing layer compresses. A suitable material for the backing layer is PORON 4701-30 from Rogers Corporation, in Rogers, Conn., or SUBA-IV from Rohm & Haas. The hardness of the backing layer can be adjusted by selection of the layer material and porosity.

In some implementations, the backing layer 104 can also be fabricated by a 3D printing process. For example, the backing layer 104 and polishing layer 102 could be fabricated in an uninterrupted operation by the additive manufacturing system 10. The backing layer 104 can be provided with a different hardness than the polishing layer 102 by using a different precursor material, and/or by using a different amount of curing, e.g., a different intensity of UV radiation.

In other implementations, the backing layer 104 is fabricated by a conventional process and then secured to the polishing layer 102. For example, the polishing layer 102 can be secured to the backing layer 104 by a thin adhesive layer, e.g., as a pressure-sensitive adhesive.

A number of embodiments have been described. Nevertheless, it will be understood that various modifications may be made without departing from the spirit and scope of the invention.

Thickness of each layer of the layers and the size of each of the voxels may vary from implementation to implementation. In some implementations, when dispensed on the support 20, each voxel can have a width of, for example, 10 μm to 50 μm (e.g., 10 μm to 30 μm, 20 μm to 40 μm, 30 μm to 50 μm, approximately 20 μm, approximately 30 μm, or approximately 50 μm). Each layer can have a predetermined thickness. The thickness can be, for example, 0.10 μm to 125 μm (e.g., 0.1 μm to 1 μm, 1 μm to 10 μm, 10 μm to 20 μm, 10 μm to 40 μm, 40 μm to 80 μm, 80 μm to 125 μm, approximately 15 μm, approximately 25 μm, approximately 60 μm, or approximately 100 μm).

The polishing pad can be circular or some other shape.

The energy source can include multiple light sources with different wavelength ranges. For example, the energy source can include two rows of UV light sources, with the two rows having different wavelength bands.

Although the apparatus has been described in the context of fabrication of a polishing pad, the apparatus can be adapted for fabrication of other articles by additive manufacturing.

Accordingly, other embodiments are within the scope of the following claims.

What is claimed is:

1. A liquid precursor for dispensing in an additive manufacturing process, the precursor material comprising:
a meth(acrylate) functional oligomer;
a reactive diluent;
a meth(acrylamide) monomer; and
a N-vinyl containing monomer.

2. The liquid precursor of claim 1, wherein the reactive diluent comprises a meth(acrylate) monomer.

3. The liquid precursor of claim 2, wherein the meth(acrylate) monomer comprises an aliphatic, cycloaliphatic, heterocyclic, aromatic, linear, and/or branched meth(acrylate) monomer.

4. The liquid precursor of claim 1, wherein the N-vinyl containing monomer comprises N,N dimethylacrylamide, N,N diethylacrylamide and/or N-vinyl pyrrolidone.

5. The liquid precursor of claim 1, wherein the oligomer provides 20-30% of the liquid precursor.

6. The liquid precursor of claim 5, wherein the oligomer provides 20-25% of the liquid precursor.

7. The liquid precursor of claim 1, comprising a photoinitiator, photosensitizer, and/or oxygen scavenger.

8. The liquid precursor of claim 1, wherein the liquid precursor consists of the meth(acrylate) functional oligomer, the reactive diluent, the meth(acrylamide) monomer, and the N-vinyl containing monomer, and optionally one or more of a photoinitiator, photosensitizer, and/or oxygen scavenger.

9. A method of fabricating a polishing layer of a polishing pad, comprising:
successively depositing a plurality of sublayers of a polishing layer with a 3D printer, each sublayer of the plurality of sublayers layers deposited by
ejecting a liquid precursor material from a nozzle, wherein the precursor material includes a meth(acrylate) functional oligomer, a reactive diluent, a meth(acrylamide) monomer, and a N-vinyl containing monomer, and
curing the precursor material to solidify the precursor material to form a solidified polishing layer material of the sublayer.

10. The method of claim 9, wherein a thickness of each sublayer of the plurality of sublayers is less than 50% of a total thickness of the polishing layer.

11. The method of claim 10, wherein a thickness of each sublayer of the plurality of sublayers is less than 1% of a total thickness of the polishing layer.

12. The method of claim 9, wherein the reactive diluent comprises a meth(acrylate) monomer.

13. The method of claim 9, wherein the N-vinyl containing monomer comprises N,N dimethylacrylamide, N,N diethylacrylamide and/or N-vinyl pyrrolidone.

14. The method of claim 9, wherein the oligomer provides 20-30% of the liquid precursor.

15. The method of claim 9, wherein the liquid precursor material consists of the meth(acrylate) functional oligomer, the reactive diluent, the meth(acrylamide) monomer, and the N-vinyl containing monomer, and optionally one or more of a photoinitiator, photosensitizer, and/or oxygen scavenger.
